(19) United States
(12) Patent Application Publication
(10) Pub. No.: US 2013/0120330 A1
(43) Pub. Date: May 16, 2013

(54) SYSTEM AND METHOD FOR OPTIMIZING VISIBILITY, AND MOBILE DEVICE OPERATING WITH OPTIMIZED VISIBILITY

(71) Applicant: Samsung Electronics Co., Ltd., Gyeonggi-do (KR)

(72) Inventors: Dongwook KANG, Gyeonggi-do (KR); Hansub Jung, Gyeonggi-do (KR)

(73) Assignee: Samsung Electronics Co., Ltd., Gyeonggi-do (KR)

(21) Appl. No.: 13/674,640

(22) Filed: Nov. 12, 2012

(30) Foreign Application Priority Data
Nov. 10, 2011 (KR) 10-2011-0116785

(51) Int. Cl. G09G 5/10

(52) U.S. Cl. CPC G09G 5/10
USPC 345/207

(57) ABSTRACT

A visibility optimization system and method is provided. The visibility optimizing system includes a display mobile device; and a measurement device. The display mobile device displays an image and adjusts a brightness level of the displayed image according to a control from the measurement device. The measurement device photographs the displayed image, compares the photographed image with reference data, and creates a visibility table based on a comparison result of the photographed image with the reference data.

### PRIORITY

This application claims priority under 35 U.S.C. §119(a) to Korean Patent Application Serial No. 10-2011-0116785, which was filed on Nov. 10, 2011 in the Korean Intellectual Property Office, the entire disclosure of which is hereby incorporated by reference.

### BACKGROUND OF THE INVENTION

1. Field of the Invention

The present invention relates generally to a system and method for optimizing visibility according to mobile devices, and to mobile devices operating with optimized visibility.

2. Description of the Related Art

Display units of mobile devices allow users to view screens on which information is displayed, so that the users can discern the displayed information. The degree of discernment by the users is commonly referred to as “visibility.”

Visibility often depends on a user's eyesight or the surrounding environments. In particular, the visibility of a screen of a display depends on surrounding luminance. Accordingly, in order to increase visibility, conventional mobile devices adjust the brightness of the display.

For example, a conventional mobile device adjusts the brightness of a screen in such a way that the brightness level decreases when the mobile device is in a dark place, and the brightness level increases when the mobile device is in a bright place. However, this conventional brightness adjustment has a disadvantage in that it does not utilize a reference value for decreasing or increasing the brightness level according to a location of the mobile device. That is, a conventional mobile device merely adjusts a brightness level of a screen based on a statistical system acquired by comparing data regarding intuitive visibility from a number of users, not utilizing a systematic or numerical control system.

Therefore, conventional mobile devices have disadvantages in that they cannot control a brightness level of a screen to provide users with a proper visibility according to a location or according to user view preferences. Accordingly, the users must manually adjust the brightness, which wastes electric power in the mobile devices, and inconveniences the users.

### SUMMARY OF THE INVENTION

Accordingly, the present invention is designed to address at least the problems and/or disadvantages described above and to provide at least the advantages described below.

An aspect of the present invention is to provide a system and method that acquire a numerical value regarding visibility and provide a proper level of brightness based on optimal visibility.

Another aspect of the present invention is to provide a mobile device operating with optimized visibility.

Another aspect of the present invention is to provide a system and method that select a range of visibility characteristics and electric power consumption according to an adjusted brightness level, thereby improving an operation efficiency of a mobile device.

Another aspect of the present invention is to provide a system and method that provide optimal visibility according to user characteristics or physical states.

In accordance with an aspect of the present invention, a visibility optimizing system is provided, which includes a display mobile device; and a measurement device. The display mobile device displays an image and adjusts a brightness level of the displayed image according to a control from the measurement device. The measurement device photographs the displayed image, compares the photographed image with reference data, and creates a visibility table based on a comparison result of the photographed image with the reference data.

In accordance with another aspect of the present invention, a visibility optimizing method is provided, which includes adjusting a brightness level of displayed images on a display mobile device; photographing the displayed images; collecting the photographed images according to preset luminance levels; comparing the collected, photographed images with reference data; and creating a visibility table based on results of comparing the collected, photographed images with reference data.

In accordance with another aspect of the present invention, a mobile device with optimized visibility is provided. The mobile device includes a communication device that receives brightness adjustment information; a display for adjusting a brightness level of a displayed image according to the brightness adjustment information; a luminance sensor for measuring an external luminance of the display; and a controller for controlling the brightness level of the display, according to the external luminance, using the brightness adjustment information. The brightness adjustment information instructs the controller to adjust a specific image displayed on the display according to brightness levels of the display, under a specific external luminance, to compare the photographed images with the reference data and to create a visibility table, to apply the visibility table and electric power consumption information according to the brightness levels, and to form levels of brightness that have a degree of visibility and an amount of electric power consumption, according to the specific external luminance.

### BRIEF DESCRIPTION OF THE DRAWINGS

The above and other aspects, features, and advantages of certain embodiments of the present invention will become more apparent from the following detailed description taken in conjunction with the accompanying drawings, in which:

FIG. 1 illustrates a visibility optimizing system according to an embodiment of the present invention;

FIG. 2 is a schematic block diagram illustrating a visibility optimizing system according to an embodiment of the present invention;

FIG. 3 is a block diagram illustrating a measurement device according to an embodiment of the present invention;

FIG. 4 illustrates a detailed view of a controller of a measurement device according to an embodiment of the present invention;

FIG. 5 is a graph illustrating brightness adjustment information, calculated via a visibility tale and electric power consumption information according to an embodiment of the present invention;

FIG. 6 is a block diagram illustrating a display mobile device according to an embodiment of the present invention;

FIG. 7 illustrates a detailed view of a device controller of a display mobile device according to an embodiment of the present invention;

FIG. 8 is a signal flow diagram illustrating a visibility optimizing method according to an embodiment of the present invention;

FIG. 9 is a flow chart illustrating a method for operating a measurement device, according to an embodiment of the present invention;

FIG. 10 illustrates photographs captured according to external luminance; and

FIG. 11 is a graph illustrating visibility calculated based on the captured photographs illustrated in FIG. 10, according to an embodiment of the present invention.

### DETAILED DESCRIPTION OF EMBODIMENTS OF THE INVENTION

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

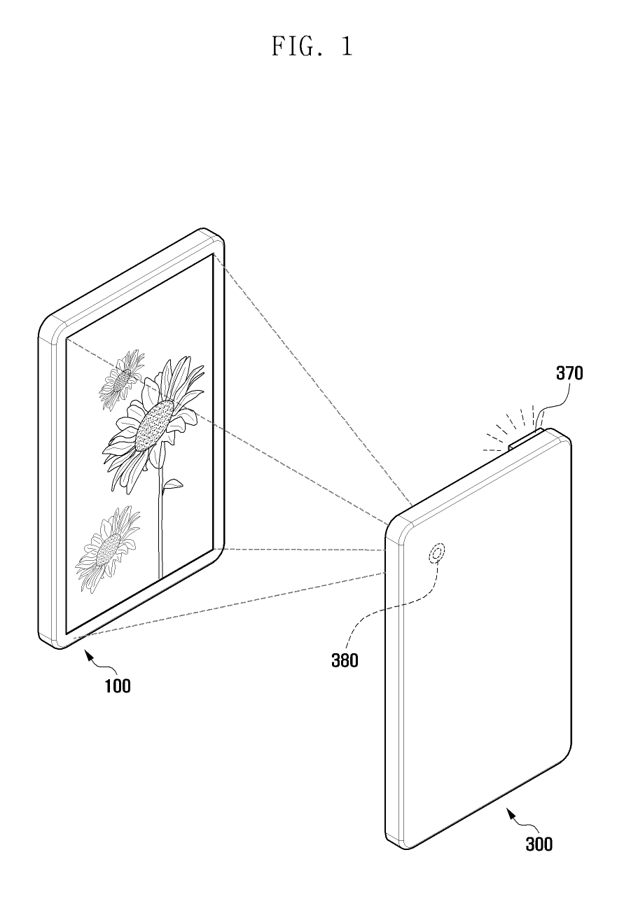

FIG. 1 illustrates a visibility optimizing system according to an embodiment of the present invention.

Referring to FIG. 1, the visibility optimizing system includes a display mobile device 100 and a measurement device 300. A camera 380 of the measurement device 300 captures images displayed on a display of the display mobile device 100, according to the respective levels of brightness, in order to collect information regarding brightness of an optimal visibility in a specific external environment. Accordingly, the visibility optimizing system collects information regarding the visibility according to variations of brightness in the display mobile device 100 by the external luminance, surrounding luminance, luminance, etc., by varying the luminance in an external environment by respective levels.

Additionally, the visibility optimizing system collects information regarding the electric power usage by the display mobile device 100 at respective levels of brightness, and creates brightness adjusting information based on the visibility and the electric power consumption. The created brightness adjusting information is transferred to the display mobile device 100 and used to make a trade-off selection between the visibility and the electric power consumption. Therefore, the visibility optimizing system automatically provides screens with optimal visibility according to respective states of mobile devices or user preferences.

More specifically, the measurement device 300 photographs a screen on the display mobile device 100, compares the photographed image with reference data, and estimates visibility. During this process, the measurement device 300 may control a light source 370, etc., in order to maintain the surroundings of the display mobile device 100 in the same condition, e.g., the same luminance, the same color temperature by light with the same wavelength, etc., for a certain period of time. Alternatively, the measurement device 300 may control the levels of brightness provided by the display mobile device 100, in order to acquire brightness information with the optimal visibility according to the external luminance.

The measurement device 300 compares images, which are photographed with levels of brightness controlled under a specific external luminance, with reference data, in order to generate a visibility table.

Additionally, the measurement device 300 associates the information regarding electric power consumption the display mobile device 100 with information in the visibility table, and calculates information for adjusting brightness to a proper level, i.e., brightness adjustment information.

For example, the reference data may be preset information or one or more images photographed from the display of the display mobile device 100, a preset image, a reference by data loss, etc. The brightness adjustment information may include values for adjusting levels of brightness according to an external luminance.

Alternatively, the brightness adjustment information may also include electric power consumption information, a visibility table, and values for adjusting a brightness level calculated via the electric power consumption information and the visibility table.

Thereafter, the calculated brightness adjustment information is provided to the display mobile device 100.

As described above, the measurement device 300 acquires the brightness adjustment information, and performs a visibility optimizing function to provide the information to a corresponding display mobile device 100. Accordingly, the measurement device 300 according to an embodiment of the present invention can adjust a brightness level of a respective display mobile device to optimize visibility with respect to inherent mechanical characteristics of the mobile device.

The display mobile device 100 outputs a specific image to the display unit under the control of the measurement device 300. The display mobile device 100 adjusts a brightness level for the specific image on the under the control of the measurement device 300. For example, the display mobile device 100 displays a specific image, from a storage unit, or an original image provided from the measurement device 300, and controls a light emitting module, e.g., a backlight, Organic Light Emitting Diodes (OLEDs), etc., to emit light in a brightness level corresponding to a value requested by the measurement device 300.

The display mobile device 100 receives control signals corresponding to adjusted brightness level values from the measurement device 300, periodically or each time that an image is photographed, so that it can adjust the brightness level of the image that is currently displayed. The display mobile device 100 receives the brightness adjustment information based on the visibility table or based on the visibility table and electric power consumption, and automatically controls the brightness level according to the received information.

Further, the display mobile device 100 collects information regarding electric power consumption according to brightness levels, and provides it according to the request of the measurement device 300.

Although the measurement device 300 illustrated in FIG. 1 is implemented as a portable terminal with a camera module, the present invention is not limited thereto. For example, the measurement device 300 may be implemented with non-portable device, such as a desktop computer. In such a case, it is preferable that the display mobile device 100 may be placed in an environment where an external luminance can be easily controlled via the measurement device 300 in order to precisely measure the visibility of the display mobile device 100.

Additionally, a light source and an environment including the light source, which can maintain the external luminance at a certain level and color temperature value, in order to perform a control operation and a measurement operation to scan light from a specific luminance in a place where the display mobile device 100 is arranged, and an luminance sensor, which can measure the luminance in an area adjacent to the display mobile device 100, may be physically included in the measurement device 300 or provided separately.

The measurement device 300 includes the digital camera 380 that supports a high performance over a certain level of resolution in order to photograph an image displayed on the display mobile device 100, with a relatively high resolution. Additionally, the light source 370, luminance sensor, and camera 380, described above, may be separated from the measurement device 300. For example, they can be connected to the measurement device 300 via communication cables or through wireless communication.

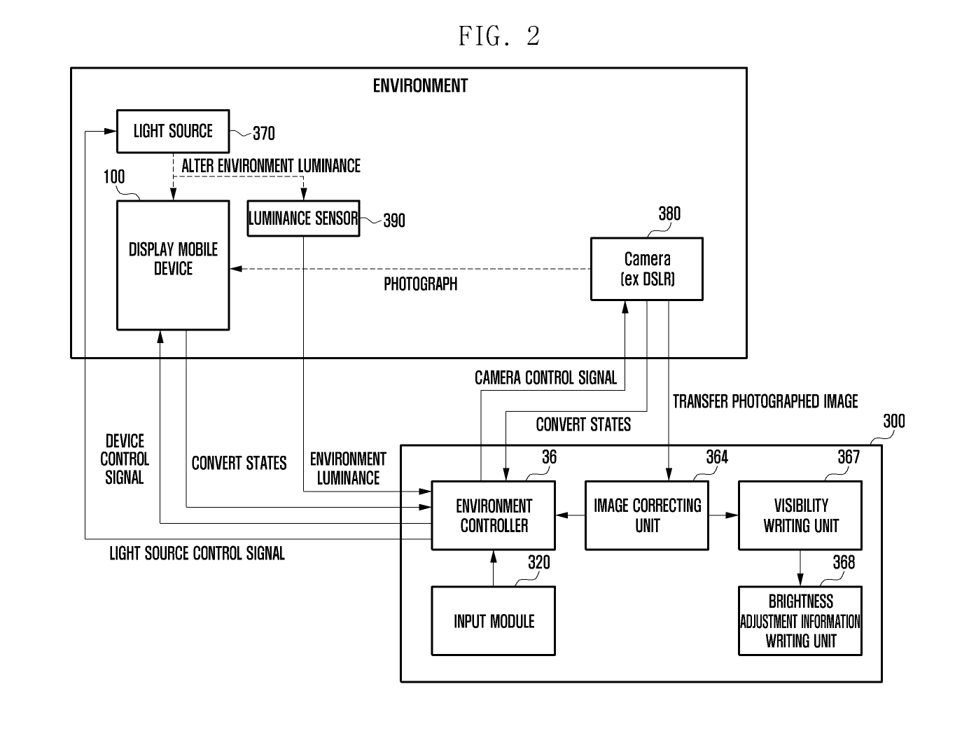

FIG. 2 is a schematic block diagram illustrating a visibility optimizing system according to an embodiment of the present invention.

Referring to FIG. 2, a display mobile device 100, a light source 370 for controlling an external luminance of the display mobile device 100, an luminance sensor 390 for sensing a luminance value in an area adjacent to the display mobile device 100 and transferring the sensed luminance value to the measurement device 300, and a camera 380 for photographing an image output from the display mobile device 100, are separate from the measurement device 300. In such a case, the measurement device 300 includes an environment controller 36, an image correcting unit 364, a visibility writing unit 367, an input module 320, and a brightness adjustment information writing information 368.

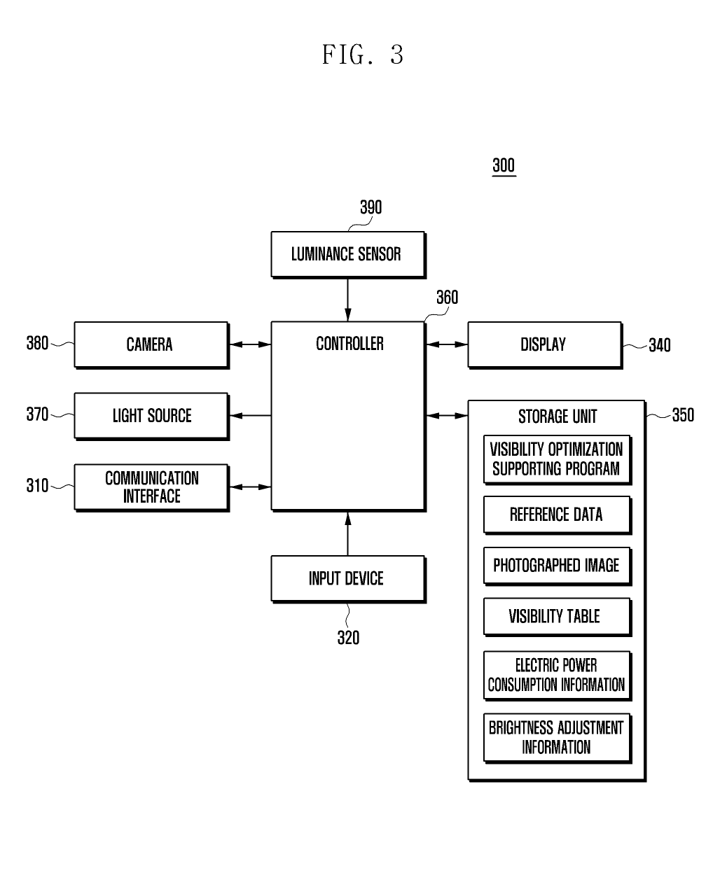

FIG. 3 is a block diagram illustrating a measurement device 300 according to an embodiment of the present invention.

Referring to FIG. 3, the measurement device 300 includes a communication interface 310, an input device 320, a display 340, a storage unit 350, a light source 370, a camera 380, a luminance sensor 390, and a controller 360. Alternatively, as described above, in the section referring to FIG. 2, the measurement device 300 may be implemented with the components other than the camera 380, light source 370, and luminance sensor 390, which are separated from the measurement device 300. In that case, the measurement device 300 is connected to the camera 380, light source 370, and luminance sensor 390, via the communication interface 310. That is, the camera 380, light source 370, and luminance sensor 390 may be integrally implemented with the measurement device 300.

Alternatively, the camera 380, light source 370, and luminance sensor 390 may be separated from the measurement device 300 and connected thereto in wireless or wired mode via the communication interface 310. In that case, the measurement device 300 may be implemented without the luminance sensor 390. In that case, the measurement device 300 may use a luminance sensor of the display mobile device 100 to collect luminance values.

The measurement device 300 controls the components described above to capture images displayed on the mobile device 100, as described above. The measurement device 300 performs numerical process with respect to the visibility of photographed images according to the operation of the installed program, and writes out the visibility information in table. Alternatively, the measurement device 300 also creates brightness adjustment information via only the visibility information. In addition, the measurement device 300 acquires information regarding electric power consumption corresponding to brightness adjustment information provided by the display mobile device 100, and associates the electric power consumption information with the visibility table, thereby creating the brightness adjustment information. The following description is provided regarding the components of the measurement device 300 when function the visibility optimization.

More specifically, the communication interface 310 establishes a communication channel between the measurement device 300 and the display mobile device 100. For example, the communication interface 310 may establish a wired communication channel with the display mobile device 100, via a connector and a cable, or may establish a wireless communication channel with the display mobile device 100. When establishing a wireless communication channel, the communication interface 310 includes, e.g., a short-range communication device or a Radio Frequency (RF) communication device. Examples of the communication interface 310 include a Bluetooth® communication device, a Wi-Fi® communication device, a mobile communication device, a 3^{rd} Generation (3G) or 4^{th} Generation (4G) communication device, a network protocol-based communication device, or any other type of communication device that can establish data communication.

The communication interface 310 transmits a specific image, brightness adjustment control values, etc., from the measurement device 300 to the display mobile device 100. Further, the communication interface 310 receives electric power consumption values according to levels of brightness from the display mobile device 100 and transfers them to the measurement device 300.

When the light source 370, camera 380, and luminance sensor 390 are embodied separately from the measurement device 300, the communication interface 310 also establishes communication channels with them, respectively.

The communication interface 310 establishes a channel to transmit luminance values of the surroundings of the display mobile device 100, acquired via the luminance sensor 390, to the measurement device 300. The communication interface 310 transmits a signal corresponding to a luminance control value and/or a color temperature control value, from the measurement device 300 to the light source 370, so that the light source 130 emits light with a specific wavelength. Further, the communication interface 310 transmits a signal corresponding to a control value from the measurement device 300 to the camera 380, and transmits photographs acquired via the camera 380 to the measurement device 300.

The input device 320 receives information for controlling the measurement device 300. For example, the input device 320 receives signals for controlling the camera 380. To this end, the input device 320 includes buttons or a button key map corresponding to controls keys for the camera 380. Further, the display unit 340 with a touch screen may also serve as the input device 320.

The input device 320 receives information corresponding to an operation pattern of a mobile device, from the manufacturer or an engineer who optimizes the visibility of the display mobile device 100. The mobile device operation pattern refers to an environment where the user uses the mobile device 100. For example, the input device 320 receives values for setting external luminance, according to a user request, according to a time period for use in an environment where a brightness level is relatively high or low.

The display 340 displays a variety of screens for controlling the measurement device 300. For example, the display 340 displays a menu screen for the measurement device 300, a screen for controlling the camera 380, a screen for controlling the light source 370, a screen for collecting luminance values, a screen for displaying photographed images, a screen for displaying electric power consumption information transmitted from the display mobile device 100, etc. The controller 360 processes the received information and outputs the result, e.g., processes the visibility in numbers, according to the comparison of photographed images with the reference data, and displays the visibility table created based on the numerical information through the display 340.

The display 340 also displays brightness adjustment information created based on the visibility table and the electric power consumption information. After identifying the information described above, the engineer determines whether the visibility optimization of the display mobile device 100 is normally performed, and if necessary, executes a specific control.

The storage unit 350 stores data and programs to control the measurement device 300. For example, the storage unit 350 stores an application program for operating the measurement device 300 and a program for driving the display 340. In accordance with an embodiment of the invention, the storage unit 350 stores a program for optimizing visibility.

The visibility optimization program writes out a visibility table based on images photographing screens on the display mobile device 100. For example, the visibility optimization program includes a number of sub-routines for transmitting tan original image to the display mobile device 100, transmitting a value for controlling a brightness level to the display mobile device 100, collecting a luminance value when light is emitted in a certain level of brightness, and controlling the light source 370 to emit light with a certain brightness level. The sub-routine for transmitting the original image may be omitted according to is the operation utilized to detect the visibility.

The visibility optimization program may also include a number of sub-routines for controlling shutter speed or an iris diaphragm of the camera 380, controlling the camera 380 to photograph an image on the display mobile device 100, and storing the photographed images according to brightness levels and levels of external luminance by the light source 370.

In addition, the visibility optimization program may also include a number of sub-routines for processing the photographed images based on reference data, generating a visibility table, collecting and storing information regarding electric power consumption by the display mobile device 100 according to brightness levels, and creating brightness adjustment information based on the visibility table and the electric power consumption information.

The storage unit 350 may store reference data previously prepared or collected during the photographing process, in order to optimize the visibility or in order to create brightness adjustment information. The storage unit 350 also stores the acquired, photographed images or acquired electric power consumption information. The stored information may be used to create the visibility table and the brightness adjustment information.

Examples of the reference data include information regarding the original image output from the display unit of the display mobile device 100, or one or more photographed images. The reference data may also be a specific image additionally inserted to images displayed on the display mobile device 100 or information as a reference for the rate of data loss in the photographed images. Types of reference data may be altered by a variety of algorithms that are used to process the visibility of photographed images.

The light source 370 emits light with a certain level of luminance and color temperature under the control of the controller 360. The light source 370 emits light toward the display mobile device 100 to expose the screen under the same level of luminance and the same color temperature. The direction of emitting light from the light source 370 can be set by the engineer. The level of luminance of the light source 370 can be maintained constantly or varied under the control of the controller 360. For example, light, emitted with a certain level of luminance from the light source 370, can be constantly maintained with respect to the total brightness level controlled by the display mobile device 100.

The camera 380 photographs images displayed by the display mobile device 100 under the control of the controller 360. The camera 380 may be implemented with a camera of a resolution over a certain value. Because the camera 380 performs a photographing process in a same setting value, it can be set to perform the average photographing process with respect to the brightness variation, and is restricted to operate the flash function. The images acquired via the camera 380 are stored in the storage unit 350. The images acquired via the camera 380 may be varied according to the brightness levels controlled by the display mobile device 100 or according to the levels of external luminance to be measured. The images photographed by the camera 380 from the display unit of the display mobile device 100 can be collected with respect to the total level of brightness of the display unit under a certain level of luminance, respectively.

The luminance sensor 390 measures the luminance surrounding the display mobile device 100. The luminance sensor 390 transfers the sensed luminance values to the controller 360. Although the luminance sensor 390 is illustrated in the measurement device 300, the invention is not limited to thereto. That is, the luminance sensor 390 may be included in the display mobile device 100 instead. When the luminance sensor 390 is included in the display mobile device 100, if the measurement device 300 requests the transmission of a luminance value from the display mobile device 100, the luminance sensor 390 of the display mobile device 100 measures a level of luminance and transmits it to the measurement device 300.

Alternatively, the luminance sensor 390 may be separated from the measurement device 300 and the display mobile device 100. In this case, the measurement device 300 establishes a wired or wireless communication channel with the luminance sensor 390 and receives luminance values therefrom via the communication channel.

The controller 360 controls the signal flow and the data transmission in order to optimize the visibility and the brightness of the display mobile device 100 according to the optimized visibility. Basically, the controller 360 controls the overall operation of the measurement device 300

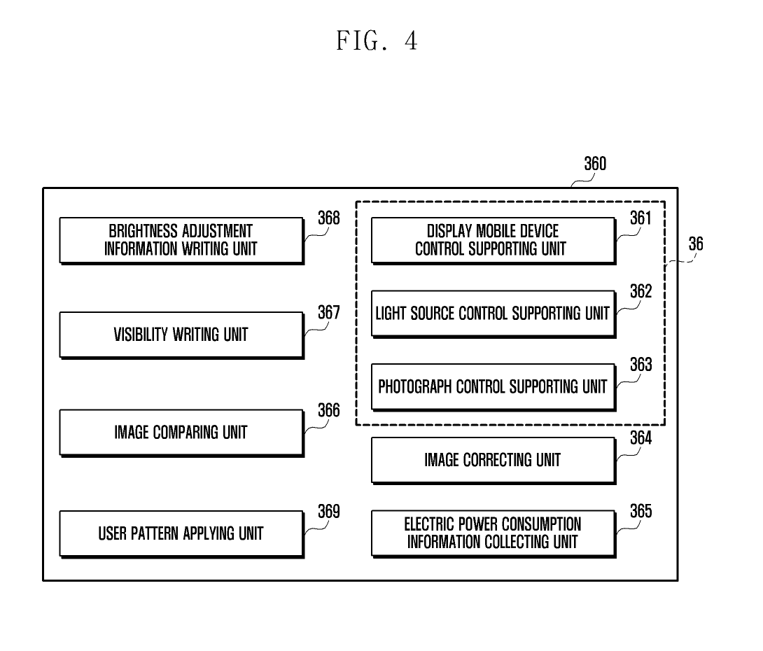

FIG. 4 illustrates a detailed view of a controller of a measurement device according to an embodiment of the present invention.

Referring to FIG. 4, the controller 360 includes a display mobile device control supporting unit 361, a light source control supporting unit 362, a photograph control supporting unit 363, an image correcting unit 364, an electric power consumption information collecting unit 365, an image comparing unit 366, a visibility writing unit 367, a brightness adjustment information writing unit 368, and a user pattern applying unit 369. The display mobile device control supporting unit 361, the light source control supporting unit 362, and the photograph control supporting unit 363 correspond to the environment controller 36 illustrated in FIG. 2.

The display mobile device control supporting unit 361 controls the operations of the display mobile device 100. The display mobile device control supporting unit 361 controls the transmission of an original image to the display mobile device 100 and the transmission of a value for controlling brightness adjustment to the display mobile device 100. The brightness adjustment information value is based on information regarding a brightness level that the display mobile device 100 can support. Accordingly, the display mobile device control supporting unit 361 receives the information regarding a brightness level from the display mobile device 100.

The display mobile device control supporting unit 361 controls the brightness of the display mobile device 100 and also provides information regarding a corresponding level of brightness to the photograph control supporting unit 363.

The light source control supporting unit 362 controls the light source 370 to emit a certain amount of light to generate a specific level of luminance. Basically, the light source control supporting unit 362 creates a value for controlling the light source 370 corresponding to a level of luminance in order to provide a preset unit of luminance, and provides the value to the light source 370.

In particular, the light source control supporting unit 362 receives a luminance value from a luminance sensor 390, arranged in an area near the display mobile device 100, or a luminance sensor 170 of the display mobile device 100, in order to identify the luminance surrounding the display mobile device 100. Thereafter, the light source control supporting unit 362 controls the amount of light from the light source 370 based on the received luminance value.

The photograph control supporting unit 363 controls the setting of the camera 380 and the photographing operation of the camera 380. The photograph control supporting unit 363 can set ISO, shutter speed, etc., of the camera 380, via a user input or preset values.

When the display mobile device 100 receives a brightness adjustment control value and controls the brightness of the display unit according to the received value, the photograph control supporting unit 363 controls the camera 380 to photograph an image on the display 140. The photograph control supporting unit 363 includes information regarding the level of brightness of the display mobile device 100 when the camera photographs an image, and information regarding an external luminance acquired by the luminance sensor 390, in the photographed image, which is stored in the storage unit 350. During the storage, the photographed image is stored in two types of frames; one of which will be compared with the reference data, and the other of which will be used to correct an image.

The image correcting unit 364 corrects photographed images. For example, images may be distorted according to the performance of the camera 380, the performance of lens, and a state in which the display mobile device 100 is held, during the photographing process. The image correcting unit 364 performs an image process with respect to photographed images to minimize the distortion, such as, twist, tilt, image quality, etc., and creates an image to be compared with the reference data. If an external luminance and the brightness of the display mobile device 100 are varied during the visibility optimizing process, without the variation of the external environment, the numbers corresponding to the visibility may be determined via the relative estimation between photographed images. Accordingly, the photographed image may not need an additional correction.

The image comparing unit 366 compares a photographed image or a photographed image that experienced an image process with the reference data. Specifically, the image comparing unit 366 calls the reference data from the storage unit 350. For example, the reference data may be an original image that is displayed on the display unit of the display mobile device 100, or may be one of the images photographed according to levels of brightness under a level of external luminance. The reference data may be a specific item in an original image, e.g., a water mark, etc. The reference data may be a rate of data loss.

In the following description, it is assumed that the reference data is an original image.

The image comparing unit 366 compares images photographed according to levels of brightness in an environment of a specific external luminance, with the original image and determines whether they match. The image comparing unit 366 processes the similarity or the identity between the photographed image and the original image to provide a numerical value representing the similarity or the identity. The numerical values are transferred to the visibility writing unit 367. If the reference data corresponds to one of the photographed images, the photographed images are compared with each other. Thereafter, if a photographed image includes data of a detailed image, it may be allocated with a relatively high data number.

If the reference data is a specific data such as a water mark, the image comparing unit 366 processes the rate of data extraction or the rate of data loss from the photographed image to provide a numerical value representing the rate of data extraction or the rate of data loss, and transfers the numerical values to the visibility writing unit 367.

The electric power consumption information collecting unit 365 collects information regarding electric power consumption when the display mobile device 100 operates under light of a certain level of brightness. For example, the electric power consumption information according to levels of brightness may be collected by measuring the electric power consumed by the display mobile device 100 according to the levels of brightness. To this end, the electric power consumption information collecting unit 365 transfers a value for adjusting brightness to the mobile device 100 and requests the transmission of the information regarding electric power consumed at a corresponding brightness level.

The visibility writing unit 367 writes out (or generates) a visibility table. The visibility writing unit 367 receives at least one of the identity, similarity, relative data number, rate of data extraction, and rate of data loss, with respect to photographed images, from the image comparing unit 366. The visibility writing unit 367 estimates the visibility with respect to the photographed images, based on the received information. That is, the more the photographed images and the original image are identical or the higher the rate of data extraction or the lower the rate of data loss, the higher grade or score the visibility writing unit 367 can allocate thereto. The visibility writing unit 367 allocates grades or scores according to the level of external luminance and the levels of brightness, and generates the visibility table including the grades or scores.

The visibility table is transferred to the brightness adjustment information writing unit 368. The visibility writing unit 367 ascertains that a photographed image has the highest number or value, or matches the original image, according to levels of brightness under an environment of an external luminance, it concludes that the photographed image has the highest visibility.

The brightness adjustment information writing unit 368 writes out brightness adjustment information based on the visibility table. Alternatively, the brightness adjustment information writing unit 368 writes out brightness adjustment information, using the visibility table and the electric power consumption information.

When writing out brightness adjustment information based on the visibility table, the brightness adjustment information writing unit 368 selects photographed images with a brightness value of the display mobile device 100 that has an optimal visibility number according to levels of external luminance, and writes out brightness adjustment information based on the brightness information included in the selected photographed images. The brightness adjustment information is provided to the display mobile device 100.

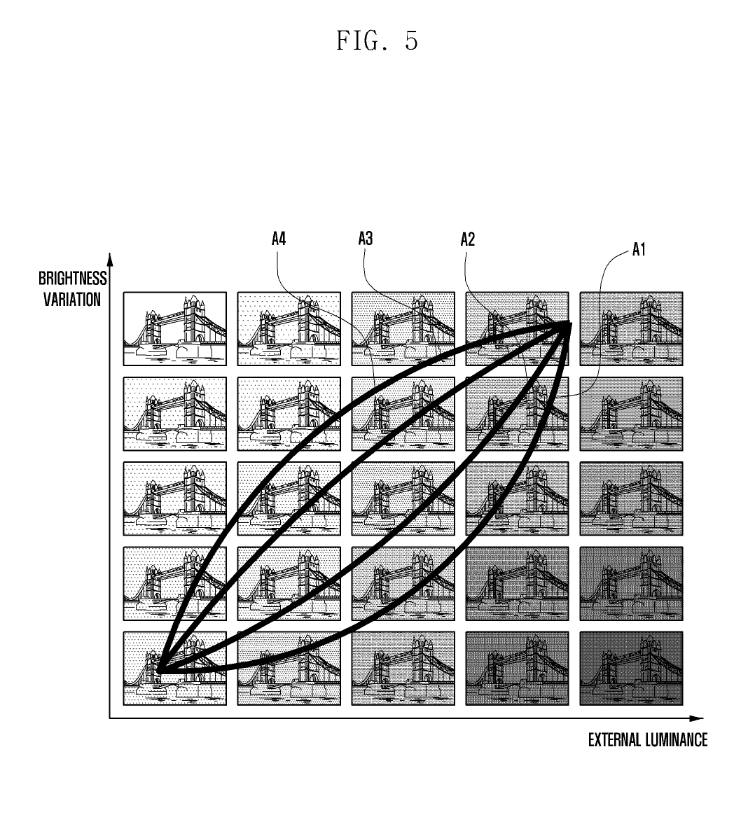

FIG. 5 is a graph illustrating brightness adjustment information, calculated via a visibility table and electric power consumption information according to an embodiment of the present invention.

Referring to FIG. 5, the brightness adjustment information writing unit 368 arrays information included in the visibility table, in matrix form, according to levels of external luminance and brightness levels of the display mobile device 100. The information included in the visibility table is displayed as photographed images. The brightness adjustment information writing unit 368 detects the electric power consumption information and the visibility with respect to photographed images, and creates the adjustment lines A1, A2, A3, and A4 that can be used to select photographed images according to the weights.

The area of a closed curve refers to an area where photographed images with a relatively high visibility number are selected within a preset amount of electric power consumption. In particular, the adjustment lines A1, A2, A3, and A4 included in the area of a closed curve may have different characteristics according to their arrayed locations. The first adjustment line A1, close to the external luminance axis, may refer to brightness adjustment information according to levels of external luminance, with a value for controlling brightness so that the weight with respect to the saved amount of electric power is greater than that of the visibility. That is, the visibility may be indicated by an adjustment line that has brightness values that consume a relatively small amount of electric power in an external luminance environment, where a preset amount or a mount greater than the preset amount is provided.

The second adjustment line A2, close to the brightness variation axis, refers to brightness adjustment information according to levels of external luminance, with a value for controlling brightness so that the weight of the visibility is greater than the weight with respect to the amount of saved electric power. That is, the adjustment line may include brightness adjustment control values to select a relatively high visibility so that electric power can be consumed a preset amount or an amount less than the preset amount in the same external luminance environment.

The brightness adjustment information writing unit 368 writes out brightness adjustment information in such a way that it includes as many of the adjustment lines A1, A2, A3, and A4 crossing the closed curve area as possible. The brightness adjustment information may be provided to the display mobile device 100.

Although the brightness adjustment information is created based on a preset number of photographed images in the descriptions above, the present invention is not limited thereto. That is, the number of photographed images used to create brightness adjustment information may increase or decrease according to levels of brightness that the display mobile device 100 can provide. In addition, the levels of external luminance may also be increased or decreased according to mobile device manufacturer settings.

The user pattern applying unit 369 may be configured in such a way that a specific adjustment line can be automatically selected from brightness adjustment information according to information regarding an environment where the user uses the display mobile device 100, or a new adjustment line can be created.

For example, if a user is mostly indoors, the user pattern applying unit 369 selects an adjustment line having a saving amount of electric power with a relatively large weight, e.g., the first adjustment line A1, as illustrated in FIG. 5, and thus, creates the brightness adjustment information. However, if a user is mostly outdoors, the user pattern applying unit 369 selects an adjustment line having a visibility with a relatively large weight, e.g., the second adjustment line A2, as illustrated in FIG. 5, and thus, creates the brightness adjustment information.

The user pattern applying unit 369 performs a control operation to write out brightness adjustment information that includes a specific adjustment line according to local areas where display mobile devices will be sold. For example, if display mobile devices are sold in local areas where it is rarely sunny, the user pattern applying unit 369 selects the first adjustment line A1 to write out brightness adjustment information. Likewise, if display mobile devices are sold in local areas where it is often sunny, the user pattern applying unit 369 selects the second adjustment line A2 to write out brightness adjustment information.

In addition, the user pattern applying unit 369 may first select the adjustment lines according to information regarding an environment where the display mobile device 100 will be used, and then provides brightness adjustment information thereto. The brightness adjustment information writing unit 368 first applies a specific adjustment line thereto, under the control of the user pattern applying unit 369, and allows the user to select the other adjustment lines according to his/her preference.

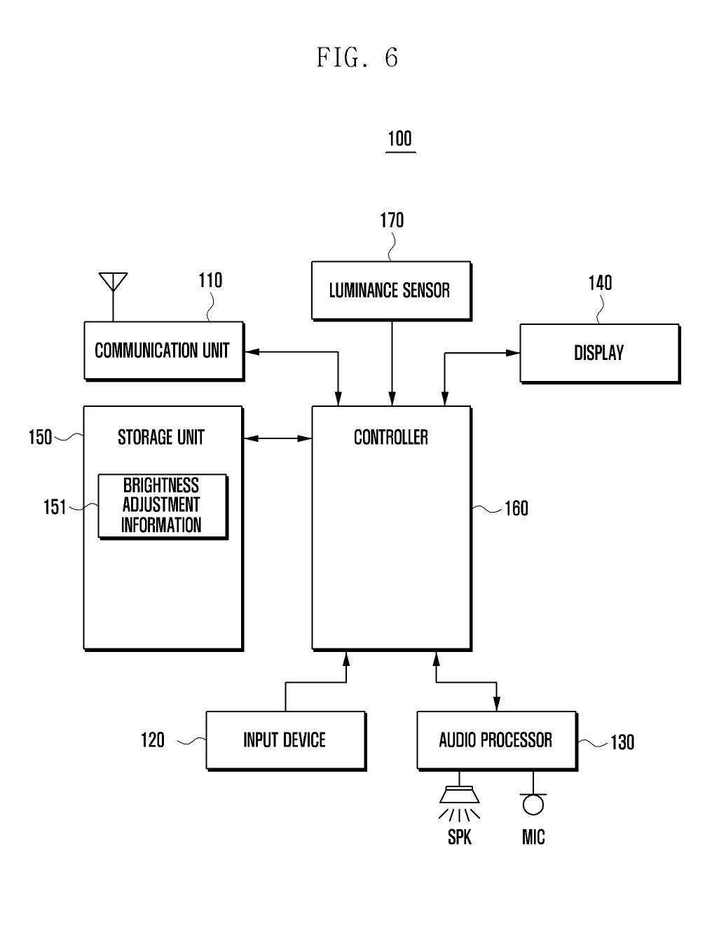

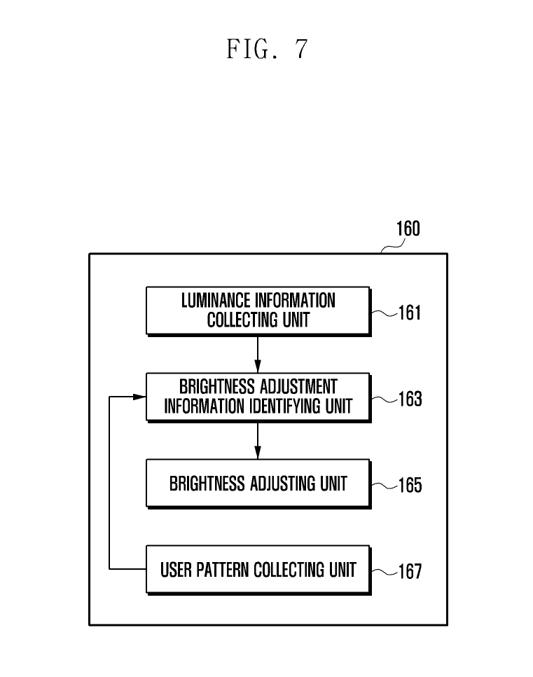

FIG. 6 is a block diagram illustrating a display mobile device according to an embodiment of the present invention. FIG. 7 illustrates a detailed view of a device controller of a display mobile device according to an embodiment of the present invention.

Referring to FIG. 6, the display mobile device 100 includes a communication unit 110, an input device 120, an audio processor 130, a display 140, a storage unit 150, a luminance sensor 170, and a controller 160.

The display mobile device 100 establishes a communication channel with the measurement device 300 via the communication unit 110. The display mobile device 100 outputs a specific image and controls the brightness according to the control of the measurement device 300. The display mobile device 100 automatically controls the brightness according to the external environment, based on the brightness adjustment information from the measurement device 300 and the information from the luminance sensor 170. Further, the display mobile device 100 can control the brightness according to a specific brightness adjustment pattern using according to a user selection or a usage pattern of the user's mobile device, based on the brightness adjustment information provided by the measurement device 300.

The communication unit 110 supports a communication function of the display mobile device 100. During the visibility optimization, the communication unit 110 establishes a communication channel to receive a control signal and transmit information from and to the measurement device 300. The communication unit 110 may be implemented with modules. The features of the modules are determined according to types of communication channels with the measurement device 300. For example, the module may be a wired communication module or a wireless communication module. The communication unit 110 receives signals for controlling levels of brightness from the measurement device 300 and replies thereto. The communication unit 110 can also transmit luminance values of the luminance sensor 170 to the measurement device 300.

The input device 120 creates signals for operating the display mobile device 100. The input device 120 may be implemented with a touch pad with key buttons, installed in the display mobile device 100. If the display 140 is implemented with a touch screen, it also serves as the input device 120.

The input device 120 creates a signal for switching on the display mobile device 100, according to a user control, during the visibility optimization. If the display mobile device 100 receives brightness adjustment information from the measurement device 300, the input device 120 creates a signal for selecting one of the adjustment lines included in the received brightness adjustment information, according to a user's control.

The audio processor 130 processes audio signals according to the operation of the display mobile device 100. The audio processor 130 may include a microphone (MIC) for collecting audio singles and a speaker (SPK) for outputting audio signals, according to types of display mobile devices. The audio processor 130 may output sound effects according to the transmission/reception of brightness adjustment information.

The display 140 displays a variety of screens for operating the display mobile device 100. Further, the display 140 displays a specific image, which is stored in the storage unit 150, or an original image provided by the measurement device 300. The original image may include a water mark, etc. The display 140 may be operated at a brightness level according to a brightness adjustment value transmitted from the measurement device 300.

The storage unit 150 stores a number of application programs and an operating system to operate the display mobile device 100. The storage unit 150 temporarily or permanently stores an original image, information regarding electric power consumption according to levels of brightness, information regarding the sensed luminance, etc., transmitted from the measurement device 300. The information regarding electric power consumption and information regarding the sensed luminance may be transmitted from the storage unit 150 to the measurement device 300, according to the control of the display mobile device 100. The storage unit 150 stores brightness adjustment information, transmitted from the measurement device 300. The brightness adjustment information 151 may be information corresponding to the feature of the display 140 of the display mobile device 100.

The luminance sensor 170 senses the luminance of the display mobile device 100. The luminance sensor 170 senses the luminance of the display 140. The sensed luminance value may be transmitted to the measurement device 300 according to the control of the display mobile device 100. The luminance sensor 170 may be activated periodically, in real time, or during the operation of the display 140, in order to apply brightness adjustment information, senses a level of external luminance, and transfers the sensed level of external luminance to the controller 160.

The controller 160 controls the entire operation of the display mobile device 100. The controller 160 controls the output of an original image during the visibility optimization. The controller 160 controls the luminance sensing operation and the transmission of electric power consumption information. When the display mobile device 100 receives brightness adjustment information from the measurement device 300, the controller 160 stores it in the storage unit 150. The controller 160 adjusts the brightness of the display 140 of the display mobile device 100, based on the stored brightness adjustment information 151. Accordingly, the controller 160 includes a luminance information collecting unit 161, a brightness adjustment information identifying unit 163, a brightness adjusting unit 165, and a user pattern collecting unit 167, as illustrated in FIG. 7.

Referring to FIG. 7, the luminance information collecting unit 161 controls the luminance sensor 170 to collect luminance information, and transmits the collected luminance information to the measurement device 300 or to the brightness adjustment information identifying unit 163. If the display mobile device 100 performs the visibility optimization and outputs a specific original image to the display 140, the luminance information collecting unit 161 senses the external luminance and transmits it to the measurement device 300.

When the display mobile device 100 activates the display 140 and performs the brightness adjustment process based on the brightness adjustment information 151, the luminance information collecting unit 161 is also activated and measures the external luminance. The luminance information collecting unit 161 transfers the measured external luminance to the brightness adjustment information identifying unit 163. Thereafter, the luminance information collecting unit 161 periodically activates the luminance sensor 170 or collects, in real time, the external luminance information. If the display unit is deactivated, the luminance information collecting unit 161 disenables the luminance sensor 170.

The brightness adjustment information identifying unit 163 receives the external luminance information from the luminance information collecting unit 161 and identifies brightness adjustment information 151 stored in the storage unit 150. The brightness adjustment information identifying unit 163 identifies a value for controlling brightness in the display mobile device 100, corresponding to the current external luminance, and transfers it to the brightness adjusting unit 165. The brightness adjustment information identifying unit 163 controls the display 140 to output the brightness adjustment information 151 so that the user can select an adjustment line of a high level of brightness that has a relatively large weight of the visibility or of the electric power saving. For example, the brightness adjustment information identifying unit 163 provides a menu for selecting a brightness adjustment line in the brightness adjustment information 151, and also a user interface when a corresponding menu item is selected. That is, the brightness adjustment information identifying unit 163 provides a user interface for allowing the user to select adjustment lines that have a number of values for controlling brightness, which have a relative difference between the weight of the visibility and the weight of the electric power saving.

The brightness adjusting unit 165 receives a brightness adjustment value from the brightness adjustment information identifying unit 163 and adjusts the brightness of the display 140 according to the value. That is, the brightness adjusting unit 165 controls the supply of electric power corresponding to the brightness adjustment value and thus adjusts the brightness of the display 140.

Alternatively, the brightness adjusting unit 165 adjusts the brightness of the display 140 according to a brightness adjustment value transmitted from the measurement device 300, when the display mobile device 100 performs the visibility optimization.

The user pattern collecting unit 167 continues to operate the luminance sensor 170 for a preset period of time.

Alternatively, the user pattern collecting unit 167 is activated when the display 140 is operated, and collects and stores external luminance information.

The user pattern collecting unit 167 provides adjustment lines where the visibility is highlighted or the electric power saving is highlighted, based on the collected external luminance information, for user selection. For example, if the amount of collected external luminance information is equal to or greater than a preset value for greater than a preset period of time, the user pattern collecting unit 167 automatically selects a brightness adjustment line where the visibility is highlighted and transfers it to the brightness adjustment information identifying unit 163. Likewise, if the amount of collected external luminance information is equal to or greater than a preset value for less than a preset period of time, the user pattern collecting unit 167 automatically selects a brightness adjustment line where the electric power saving is highlighted and transfers it to the brightness adjustment information identifying unit 163.

As described above, the visibility optimizing system and the mobile devices thereof create brightness adjustment information for optimizing the visibility according to the display mobile devices and adjust the brightness of the display mobile devices based on the information.

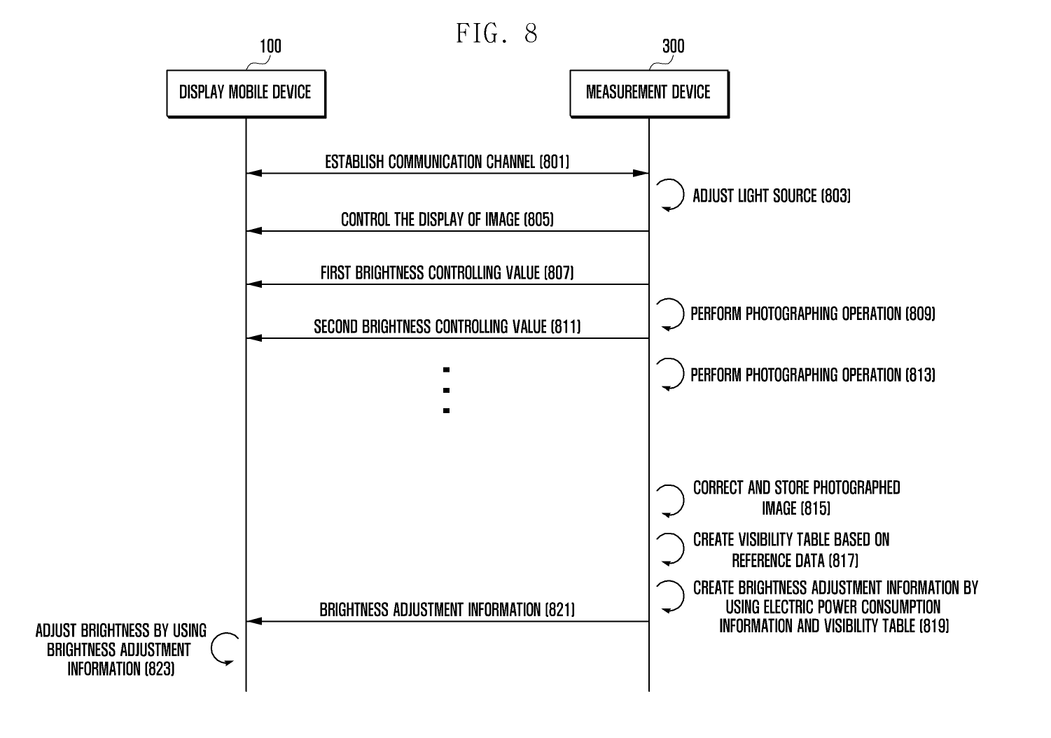

FIG. 8 is a signal flow diagram illustrating a visibility optimizing method according to an embodiment of the present invention.

Referring to FIG. 8, the display mobile device 100 establishes a communication channel with the measurement device 300 in step 801. To this end, the display mobile device 100 and the measurement device 300 are switched on and thus have completed the initialization process, respectively. The communication interface 310 of the measurement device 300 is connected to the communication unit 110 of the display mobile device 100, in a wired mode using cables or in a wireless mode using wireless communication modules.

In step 803, the measurement device 300 controls the light source 370. Specifically, the measurement device 300 controls the luminance sensor 390 to sense an external luminance around the display 140 of the display mobile device 100 and acquires the external luminance value.

Alternatively, the measurement device 300 requests an external luminance value from the display mobile device 100. In this case, the display mobile device 100 controls the luminance sensor 170 to sense the external luminance and transmits the sensed external luminance to the measurement device 300. After collecting the external luminance value, the measurement device 300 creates a value for controlling an amount of light from the light source 370 to provide a specific external luminance value that was previously defined via a corresponding external luminance, and then transmits it to the light source 370.

In step 805, the measurement device 300 controls the display of an image on the display mobile device 100. For example, the measurement device 300 transmits an original image to the display mobile device 100. That is, the measurement device 300 prepares one or more original images and transmits them to the display mobile device 100, so that the display mobile device 100 displays the received images on the display 140.

Alternatively, the measurement device 300 may request the display mobile device 100 to display a specific image, stored in the display mobile device 100, on the display 140.

In step 807, the measurement device 300 transmits a first brightness controlling value to the display mobile device 100. The first brightness controlling value refers to a value for operating the display 140 in one of a number of levels of brightness provided by the display mobile device 100, e.g., a value for controlling the display 140 in the darkest brightness level. The display mobile device 100 receives the first brightness controlling value and adjusts the screen on the display 140 in a brightness level corresponding to the value.

When the display mobile device 100 controls the brightness level of the display 140 in the first level of brightness according to the first brightness controlling value, the measurement device 300 photographs the image displayed on the display 140 of the display mobile device 100 in step 809.

After photographing the image, the measurement device 300 transmits a second brightness controlling value to the display mobile device 100 in step 811. The display mobile device 100 controls the voltage or current of the backlight or the OLEDs of the display 140, according to the second brightness controlling value, operating the display 140 at the second brightness level. When the brightness level of the display 140 is adjusted, the measurement device 300 photographs the image displayed on the display 140 in step 813.

The measurement device 300 performs an application operation of the steps described above according to the brightness adjustment steps of the display mobile device 100. That is, the measurement device 300 transmits brightness controlling values to the display mobile device 100 and repeatedly performs an image photographing process of the display mobile device 100 corresponding to the values.

After adjusting the brightness level of the display mobile device 100, the measurement device 300 corrects and stores the photographed image in step 815.

The measurement device 300 may further control the light source 370 to alter the external luminance and then re-perform steps 805 to 811 according to the levels of brightness of the display mobile device 100.

In step 817, the measurement device 300 creates a visibility table using the photographed images and the reference data. In step 819, the measurement device 300 collects electric power consumption information according to levels of brightness of the display mobile device 100, and creates brightness adjustment information by using the electric power consumption information and the visibility table.

Alternatively, the measurement device 300 may create brightness adjustment information that includes the photographed images with the optimal visibility, only using the visibility table, i.e., without using the electric power consumption information.

In step 821, the measurement device 300 transmits the created brightness adjustment information to the display mobile device 100. The display mobile device 100 receives the brightness adjustment information, and controls a brightness adjusting process according to the received information in step 823.

Accordingly, the display mobile device 100 measures the external luminance, and then adjusts the brightness level of the display 140 so that it has the optimal visibility under the measured external luminance environment or controls the display 140 to have a brightness level where the visibility is proper and a proper amount of electric power is consumed.

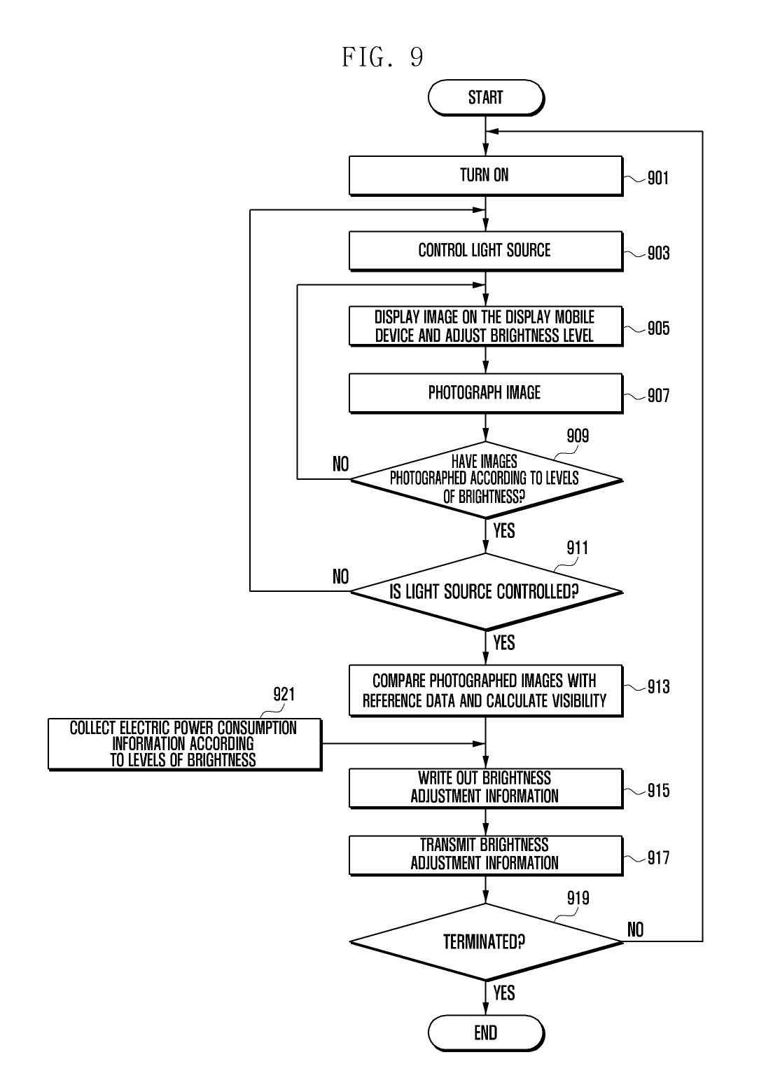

FIG. 9 is a flow chart illustrating a method for operating a measurement device, according to an embodiment of the present invention.

Referring to FIG. 9, the measurement device 300 is switched on and the components thereof are initialized in step 901. In particular, the measurement device 300 enables components related to the visibility optimization.

In step 903, the measurement device 300 controls the light source 370. That is, the measurement device 300 controls the amount of light from the light source 370 so that the display mobile device 100 is placed under an environment of a preset luminance. Accordingly, the measurement device 300 previously acquires the specification of the light source 370. Therefore, the measurement device 300 has control values to be transmitted to the light source 370 in order to acquire a corresponding luminance.

Alternatively, the measurement device 300 collects luminance values via the luminance sensor 390 or the luminance sensor 170 of the display mobile device 100. The measurement device 300 increases or decreases the amount of light from the light source 370 based on the collected luminance values, providing a preset external luminance.

In step 905, the measurement device 300 controls the display of an image on the display mobile device 100 and the brightness level. Specifically, the measurement device 300 provides an original image to the display mobile device 100, and transmits values for adjusting levels of brightness of the display 140 to the display mobile device 100. The currently transmitted brightness adjusting value corresponds to a higher or lower level of brightness than a value that was previously transmitted.

Alternatively, the first transmitted brightness adjusting value may be a value corresponding to the lowest or highest level of brightness provided by the display mobile device 100.

In step 907, the measurement device 300 photographs an image displayed on the display 140 of the display mobile device 100. Alternatively, if the measurement device 300 ascertains that images have been photographed at step 907, it can perform an image correction for the photographed images.

In step 909, the measurement device 300 determines whether images are photographed according to levels of brightness of the display mobile device 100. If the measurement device 300 ascertains that images have not photographed according to levels of brightness of the display mobile device 100 in step 909, the process returns to step 905.

Alternatively, if the measurement device 300 ascertains that images have been photographed at step 907, it can perform an image correction for the photographed images.

However, if the measurement device 300 ascertains that images have photographed according to levels of brightness of the display mobile device 100 in step 909, the measurement device 300 determines whether the light source 370 should be controlled in step 911.

If the measurement device 300 ascertains that the light source 370 is required to be controlled in step 911, the measurement device 300 controls the light source 370 to emit light with an external luminance and the method returns to step 903, where the light source 370 is controlled to emit light with the adjusted amount of light. The light source 370 is controlled so that images can be photographed, according to levels of brightness, from the display 140 of the display mobile device 100, under an environment of a variety of external luminance. The environment of a variety of external luminance may be set according to the engineers, referring to luminance conditions, such as indoors, outdoors, location areas, forenoon, afternoon, etc.

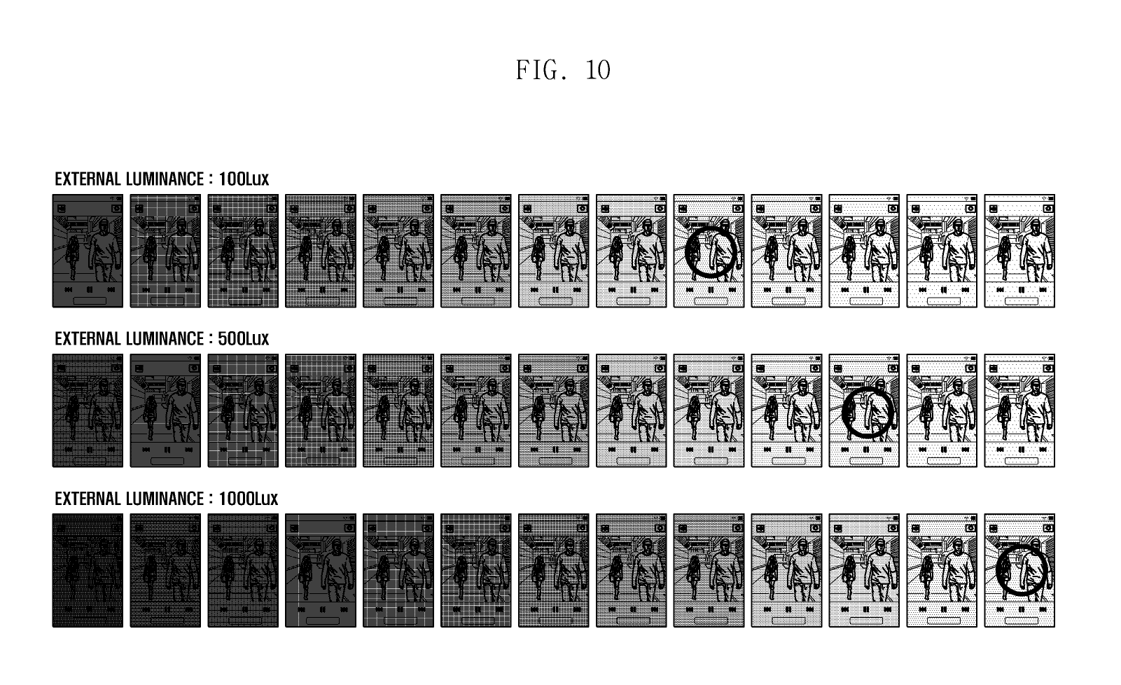

For example, FIG. 10 illustrates photographs captured according to external luminance. As illustrated in FIG. 10, the measurement device 300 photographs images, according to levels of brightness, according to levels of external luminance, and collects the photographed images.

However, if the measurement device 300 ascertains that the light source 370 is not required to be controlled, i.e., the variation in the external luminance to be detected has been completed, in step 911, the measurement device 300 compares the photographed images with the reference data and then creates the visibility in step 913. The measurement device 300 checks at least one of the identity and the similarity between the photographed images and the reference data, the relative data number, the rate of extracting specific data that is inserted, and the rate of data loss, and creates the visibility based on the checked result.

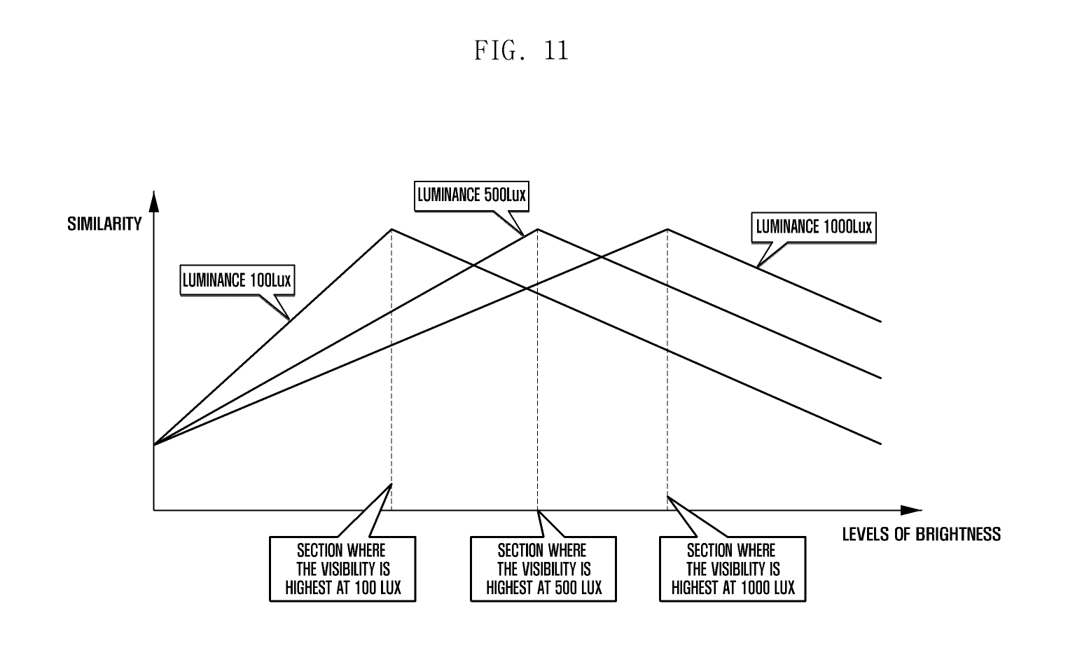

FIG. 11 is a graph illustrating visibility calculated based on the captured photographs illustrated in FIG. 10, according to an embodiment of the present invention. If the visibility has been created, the numeral values are expressed as graphs, as illustrated in FIG. 11. The measurement device 300 can detect a level of brightness with an optimal visibility according to levels of external luminance, refereeing to the graphs.

Referring again to FIG. 9, the measurement device 300 creates brightness adjustment information based on the visibility information in step 915. The measurement device 300 transmits the created brightness adjustment information to the display mobile device 100 in step 917. The measurement device 300 determines whether a signal for terminating the visibility optimizing operation is received in step 919.

If the measurement device 300 ascertains that a signal for terminating the visibility optimizing operation has not been received in step 919, the method returns to step 901. That is, the measurement device 300 performs a visibility optimizing process with respect to the other display mobile device.

Although measurement device 300 creates the brightness adjustment information based on the visibility information in step 915, alternatively, the measurement device 300 can create the brightness adjustment information using electric power consumption information according to levels of brightness of the display mobile device 100 in step 921. That is, the measurement device 300 can create brightness adjustment information so that the display unit operates in a level of brightness where a relatively low amount of electric power is consumed, with a proper degree of visibility, based on the electric power consumption information and the visibility table as illustrated in FIG. 5.

The systems and methods for supporting the visibility optimization and the mobile devices using the same, according to the above-described embodiments of the present invention, can adjust levels of brightness, according to levels of external luminance with optimal visibility corresponding to mechanical characteristics according to respective display mobile devices. The systems, methods, and mobile devices can collect electric power consumption information according to levels of brightness, and can adjust brightness with a proper degree of visibility and a relatively small amount of electric power consumption. The systems, methods, and the mobile devices can also adjust a level of brightness, considering the visibility first or the electric power consumption first, according to the user preferences.

As described above, the systems and methods for optimizing visibility acquire a numerical value representing visibility and allow the mobile device to operate based on the optimal visibility. Further, the systems and methods provide an optimal visibility to mobile devices, so that the mobile devices can properly adjust the brightness level in corresponding environments.

The systems and methods can optimally adjust the brightness level, considering the features of mobile devices, and the electric power consumption and the visibility according to users.

Although it is not shown in the drawings, the display mobile device 100 may selectively further include various types of components, for example: a short-range communication module for short-range communication; a camera module for acquiring still images/videos; an interface for transmitting/receiving data in a wireless or weird mode; an Internet communication module; and a digital broadcast module for receiving and reproducing broadcasts. With the spread of digital convergence, although it is impossible to list all the modifications of mobile devices in this description, it will be easily appreciated to those skilled in the art that the other components equivalent to the above-listed components may be further included to the mobile device according to the invention. Also, it will be appreciated that, according to the purposes, the mobile device may be implemented by omitting a particular component or replacing it with other components.

The mobile devices according to the present invention include all information communication devices, multimedia devices, and their applications, which are operated according to communication protocols corresponding to various types of communication systems. For example, a mobile device can be applied to mobile communication terminals, Portable Multimedia Players (PMPs), digital broadcast players, Personal Digital Assistants (PDAs), audio players (e.g., MP3 players), mobile game players, smartphones, laptop computers, hand-held PC, etc.

While the present invention has been particularly shown and described with reference to certain embodiments thereof, it will be understood by those of ordinary skill in the art that various changes in form and details may be made therein without departing from the spirit and scope of the present invention as defined by the following claims and their equivalents.

What is claimed is:

1. A visibility optimizing system, comprising:
a display mobile device; and
a measurement device,
wherein the display mobile device displays an image and adjusts a brightness level of the displayed image according to a control from the measurement device, and
wherein the measurement device photographs the displayed image, compares the photographed image with reference data, and creates a visibility table based on a comparison result of the photographed image with the reference data.

2. The system of claim 1, wherein the measurement device creates brightness adjustment information indicating a brightness level to be adjusted according to an external luminance of the display mobile device, based on brightness levels with a comparison characteristic value of the visibility table.

3. The system of claim 1, wherein the measurement device collects electric power consumption information according to the brightness levels of the display mobile device and creates brightness adjustment information that includes at least one brightness level adjustment value based on the collected electric power consumption information and the visibility table.

4. The system of claim 3, wherein the brightness adjustment information that comprises at least one of:
a brightness adjusting value of brightness levels, where a weight of electric power saving is relatively greater than a weight of visibility; and
a brightness adjusting value of brightness levels, where the weight of the visibility is relatively greater than the weight of the electric power saving.

5. The system of claim 3, wherein the measurement device transmits the brightness adjustment information to the display mobile device.

6. The system of claim 5, wherein the display mobile device comprises:
a luminance sensor for sensing the external luminance;
a controller for automatically controlling the brightness level, based on the sensed external luminance and the brightness adjustment information; and
a display,
wherein the brightness level of the display is adjusted by the controller.

7. The system of claim 1, further comprising:
a luminance sensor for sensing an external luminance of the mobile device and providing the external luminance to the measurement device; and
a light source for emitting light at at least one of a specific luminance and a color temperature, according to the control of the measurement device, based on the external luminance sensed by the luminance sensor.

8. The system of claim 1, wherein the reference data comprises at least one of:
an original image of an image displayed on the display unit;
a photographed image;
a specific image inserted to the displayed image; and
reference information regarding a rate of data loss from the photographed image.

9. The system of claim 8, wherein the visibility table is created via at least one of:
a numerical value representing an identity or similarity between the original image and the photographed images;
a numerical value representing the rate of data loss by comparing the photographed images with each other; and
a numerical value representing a rate of data extraction with respect to the specific image inserted to the displayed image.

10. A visibility optimizing method, the method comprising:
adjusting a brightness level of displayed images on a display mobile device;
photographing the displayed images;
collecting the photographed images according to preset luminance levels;
comparing the collected, photographed images with reference data; and
creating a visibility table based on results of comparing the collected, photographed images with reference data.

11. The method of claim 10, further comprising:
collecting electric power consumption information at different brightness levels of the display mobile device;
creating brightness adjustment information using the collected electric power consumption information and the visibility table; and
providing the brightness adjustment information to the display mobile device.

12. The method of claim 11, wherein the brightness adjustment information comprises at least one:
a brightness adjusting value of brightness levels, where a weight of electric power saving is relatively greater than a weight of visibility; and
a brightness adjusting value of brightness levels, where the weight of the visibility is relatively greater than the weight of the electric power saving.

13. The method of claim 11, further comprising:
collecting, by the display mobile device, luminance information; and
adjusting the brightness levels of the display mobile device according to the luminance information and the brightness adjustment information.

14. The method of claim 11, wherein adjusting the brightness level of the displayed images on the display mobile device comprises:
automatically selecting, if a luminance information pattern of the display mobile device corresponds to an environment where an external luminance is greater than a preset value for greater than a preset period of time, the brightness adjustment information that includes a level of brightness where a weight of the visibility is relatively greater than a weight of the electric power saving; and
automatically selecting, if the luminance information pattern of the display mobile device corresponds to an environment where an external luminance is less than a preset value for greater than a preset period of time, the brightness adjustment information that includes a level of brightness where the weight of the electric power saving is relatively greater than the weight of the visibility.

15. The method of claim 10, further comprising:
collecting information regarding an external luminance of the display mobile device; and
adjusting an amount of light from a light source according to the external luminance information, to provide at least one of a preset external luminance or a preset external color temperature.

16. The method of claim 10, wherein comparing the collected, photographed images with reference data comprises at least one of:
comparing the photographed images with an original image to acquire an identity or similarity therebetween;
comparing the photographed images with each other to acquire a rate of data loss; and
acquiring a rate of data extraction with respect to a specific inserted image.

17. A mobile device operated with optimized visibility, the mobile device comprising:
a communication device that receives brightness adjustment information;
a display for adjusting a brightness level of a displayed image according to the brightness adjustment information;
a luminance sensor for measuring an external luminance of the display; and
a controller for controlling the brightness level of the display, according to the external luminance, using the brightness adjustment information,
wherein the brightness adjustment information instructs the controller to adjust a specific image displayed on the display according to brightness levels of the display, under a specific external luminance, to compare the photographed images with the reference data and to create a visibility table, to apply the visibility table and electric power consumption information according to the brightness levels, and to form levels of brightness that have a degree of visibility and an amount of electric power consumption, according to the specific external luminance.

18. The mobile device of claim 17, wherein the display outputs a user interface for selecting one of a number of brightness adjustment lines that include brightness adjusting values where a weight of visibility is relatively greater than a weight of electric power saving, or the weight of the electric power saving is relatively greater than the weight of the visibility.

19. The mobile device of claim 17, wherein, if the controller ascertains that a luminance information pattern of the display corresponds to an environment where an external luminance is greater than a preset value for greater than a preset period of time, the controller applies the brightness adjustment information having a brightness adjusting value where a weight of the visibility is relatively greater than a weight of the electric power saving.

20. The mobile device of claim 17, wherein, if the controller ascertains that a luminance information pattern of the display corresponds to an environment where an external luminance is less than a preset value for greater than a preset period of time, the controller applies brightness adjustment information having a brightness adjusting value where a weight of electric power saving is relatively greater than a weight of visibility.
